(19) United States
(12) Patent Application Publication
(10) Pub. No.: US 2016/0108882 A1
(43) Pub. Date: Apr. 21, 2016

(54) Instant-on automotive vehicle heater/defroster

(71) Applicant: Robert Tretiak, Las Vegas, NV (US)

(72) Inventor: Robert Tretiak, Las Vegas, NV (US)

(21) Appl. No.: 14/515,411

(22) Filed: Oct. 15, 2014

(51) Int. Cl. F02N 19/10

(52) U.S. Cl. CPC F02N 19/10

(57) ABSTRACT

This patent application is intended to eliminate the fuel and time-wasting need to warm up a vehicle engine in order to defog windows and provide cabin warmth for passenger safety and comfort. It utilizes an electric heating element, which turns on instantly if it senses, through the use of a thermocouple in the radiator, that the engine radiator water/coolant is cold. Once the thermocouple senses that the engine radiator water/coolant has warmed up, it turns off the electric heating element, thus allowing the heated engine coolant/water to provide the source of heat once the engine reaches operating temperature. There do exist some vehicles that use solely an electric heating element, rather than using the engine water/coolant as a source of heating and defrosting. Most vehicles use only the engine water/coolant to provide the heating and defrosting. But, there are none that use both an electric heating element to create instant heat, and then switch to the heated engine water/coolant as a source of warmth.

When the vehicle heater and/or defroster is turned on, a thermocouple in the radiator detects the temperature of the water. If the water is cold,, an electric heating element is activated, over which the fan blows heater system air to heat the vehicle cabin and the defroster. When the thermocouple senses that the radiator water has attained operating temperature, the electric heating element is turned off, allowing the engine-heated water to operate as usual to heat the vehicle cabin and defroster.

This eliminates the fuel and time-wasting need to warm up the vehicle engine in order to defog windows and provide cabin warmth for passenger safety and comfort.

1. This patent application is for the means of controlling the switching an electric heater element on and off by means of a thermocouple in the radiator, which turns the heater element on when the engine is cold and turns the heater element off when the engine warms up, thus allowing the heated engine coolant/water to provide the source of heat once the engine reaches operating temperature.
